(19) United States
(12) Patent Application Publication
(10) Pub. No.: US 2024/0033953 A1
(43) Pub. Date: Feb. 1, 2024

(54) Box cutter knife with mechanism for breaking tip blade

(71) Applicant: Oran Schneider, Bar Yohai (IL)

(72) Inventor: Oran Schneider, Bar Yohai (IL)

(21) Appl. No.: 17/874,290

(22) Filed: Jul. 27, 2022

(51) Int. Cl. B26B 1/08

(52) U.S. Cl. CPC B26B 1/08

(57) ABSTRACT

A box cutter knife includes a housing handle, a sliding blade, and a snap-off mechanism. The sliding blade is positioned inside the housing handle and comprises a plurality of blade tips and a break line between any two adjacent blade tips. The snap-off mechanism comprises a pushing element that is axially connected to the housing handle and a raised resisting element that is attached to the inner wall of the housing handle. The pushing element and the raised resisting elements are connected to the housing handle in such a way that they are adjacent to both sides of the sliding blade. A rotation of the pushing element applies force on the front blade tip and breaks it at its break line, while the raised resisting element exerts a counter force.

### FIELD OF THE INVENTION

The present invention refers to a box cutter knife with a snap-off mechanism for breaking the tip blade.

### BACKGROUND ART

Box cutter knifes are widely used in almost every home and many professionals use them on a daily basis. The standard box cutter knife includes a main body that serves as a handle of the box cutter knife and as housing of the sliding blade that can slide and extend outside of the housing handle and inside into the housing handle by the sliding button. The sliding blade comprises of a plurality of blade tips, each of which ends with the marking of a break line of that blade tip. From time to time the user should snap-off the front blade tip that is no longer sharp enough. It is common to snap off the front blunt tip by using a piece of plastic that is assembled in the back part of the housing handle, or using pliers, or as most users do, bend the front tip on the floor or a hard surface, apply pressure to the blade, tilt the face to the side, close the eyes and hope that the tip will not rebound as ricochet to the face. The present invention discloses an innovative solution for this problem.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 depicts the sliding blade.

FIGS. 2-6 depict the sliding blade with the pushing and resisting elements.

FIGS. 7-8 depict the sliding blade with a pushing element (51) in a shape of a pin that is springy connected to the housing handle.

FIGS. 9-12 depict the sliding blade with the snap-off mechanism (5) that includes the main piece (60) with the narrow passage (61).

FIGS. 13A-13F depict the main piece (60) with the narrow passage (61).

FIGS. 14-15 are an exploded view of the box cutter knife (1).

FIG. 16 depicts the box cutter knife (1).

FIG. 17 is an upper cross-sectional view the box cutter knife (1).

FIGS. 18-19 are an exploded upper cross-sectional view the box cutter knife (1).

FIG. 20 is an upper cross-sectional view the box cutter knife (1).

FIGS. 21-22 are an exploded upper cross-sectional view the box cutter knife (1).

### THE INVENTION

The objective of the present invention is to provide a box cutter knife (1) that includes a main body that serves as a handle of the box cutter knife and as housing of a sliding blade (2). We will refer to the main body hereinafter and in the claims with the term “a housing handle”. The sliding blade (2) can slide and extend outside of the housing handle (3) and inside into the housing handle (3) by using a sliding button (4). The sliding button is connected to the sliding blade and is designed to slide and move the sliding blade back and forth inside the housing handle (and outside of the housing handle). The sliding blade (2) comprises of a plurality of blade tips (20) and a break line (21) between any two adjacent blade tips. The description of the above parts and their operation are known to experts in the field and therefore there is no need to describe them in detail.

The box cutter knife (1) also includes a snap-off mechanism (5) that is the main innovative element of the box cutter knife (1) of the present invention. The snap-off mechanism (5) comprises a pushing element (51) and a raised resisting element (52).

The pushing element (51) is axially connected to the house handle by a hinge (53), and the raised resisting element (52) is attached to an inner wall (31) of the housing handle. The pushing element is axially connected to the housing handle in such a way that it is adjacent to a first side (22) of the sliding blade, and the raised resisting element is attached to the inner wall of the housing handle in such a way that it is adjacent to a second side (23) of the sliding blade.

When the user wants to break the front used blade tip (20A) that no longer has a sharp edge the user can retract the sliding blade so that the front blade tip is positioned to the side of the snap-off mechanism so that a rotation of the pushing element can cause the pushing element to apply sided force onto the front blade tip and break it at the break line, while the raised resisting element exerts a counter force on that break line or on the next blade tip (20B) that is adjacent to the front blade tip.

The pushing element may have a handle (511) to make it easier for the user to rotate the pushing element. It is possible for the pushing element to be axially connected to the housing handle in such a way that pushing the handle (511) towards the housing handle will cause the pushing element to rotate and break the front blade tip, or rather pulling the handle out from the direction of the housing handle will cause the pushing element to rotate and break the front blade tip. The resisting element (52) may have a slope (521) as depicted for example in FIG. 6 in such a way that the front blade tip breaks when it is almost parallel and almost adjacent to the slope of the resisting element for preventing the breaking tip from flying, or alternatively there will be a soft element (55) adjacent to the resisting element designed to dampen the aforementioned flight.

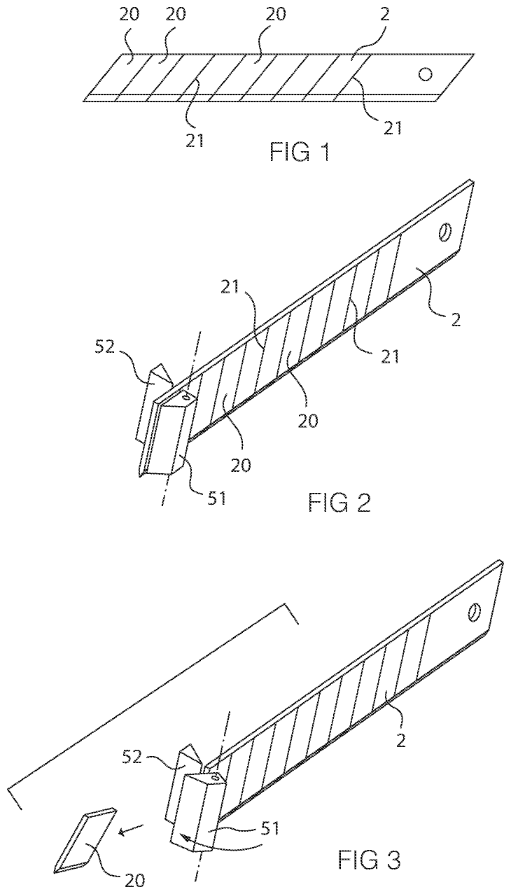

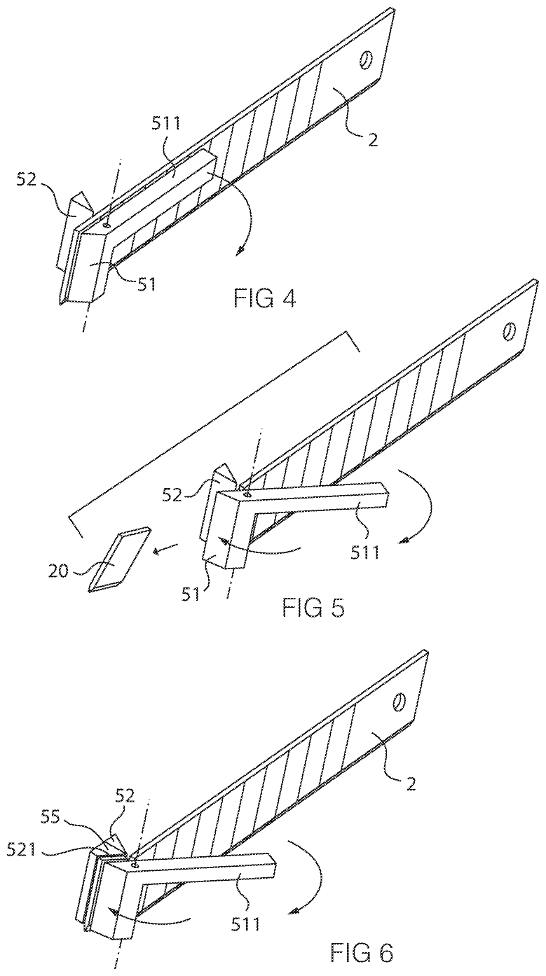

FIG. 1 depicts the sliding blade, FIGS. 2-6 depict the sliding blade with the pushing and resisting elements.

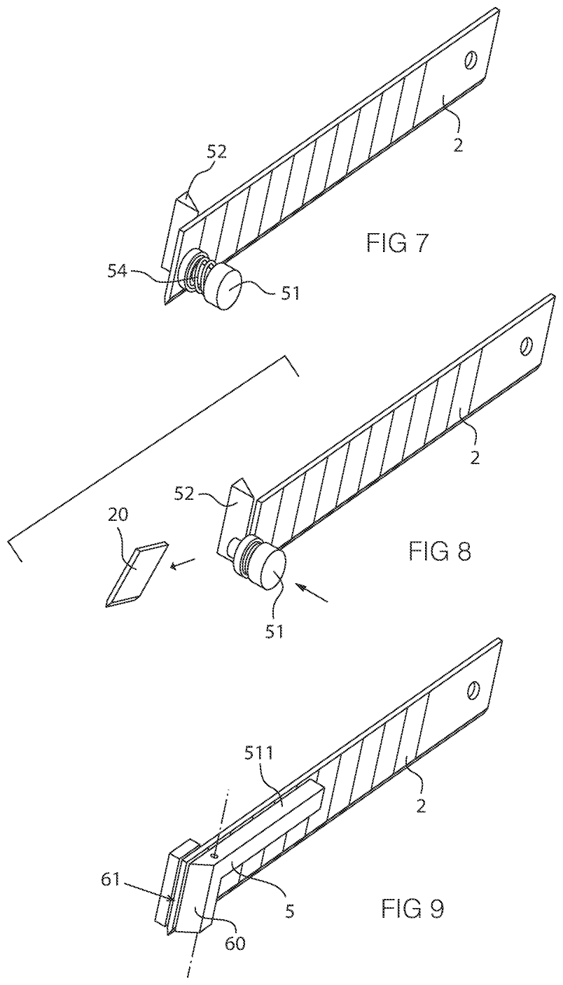

In another embodiment of the box cutter knife (1) the pushing element (51) is springy connected to the housing handle by a spring (54) and it can be in a shape of a pin with a head so that when the user pushes the pushing element towards the housing handle the pushing element breaks the front blade tip. FIGS. 7-8 depict the sliding blade with a pushing element (51) in a shape of a pin that is springy connected to the housing handle.

In another embodiment of the box cutter knife (1) the snap-off mechanism (5) comprises a main piece (60) with a narrow passage (61) in a form of a tunnel or channel through which the sliding blade (2) can pass when extending outside of the housing handle in the normal usage of the box cutter knife. The snap-off mechanism (5) in this embodiment is also axially connected to the housing handle by a hinge (53), but in such a way that when the snap-off mechanism rotates it can apply sided force onto a front blade tip (20A) of the sliding blade and break it at a break line (21A) between said front blade tip (20A) to its adjacent blade tip (20B).

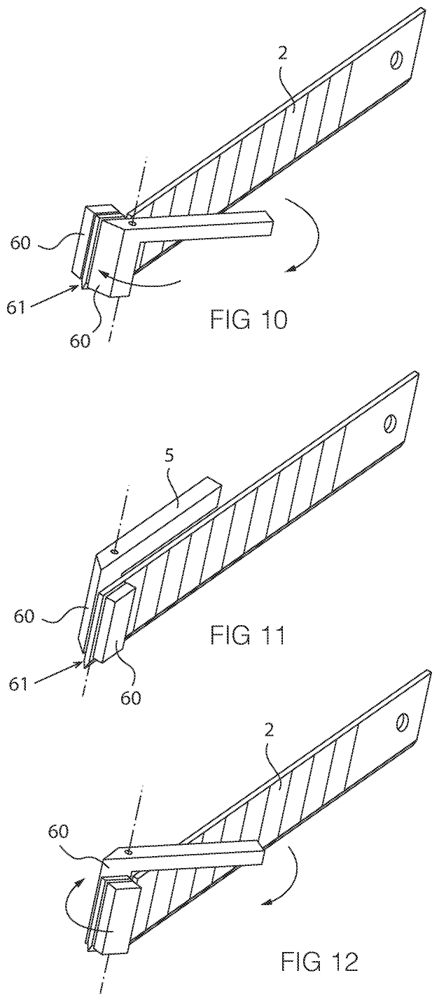

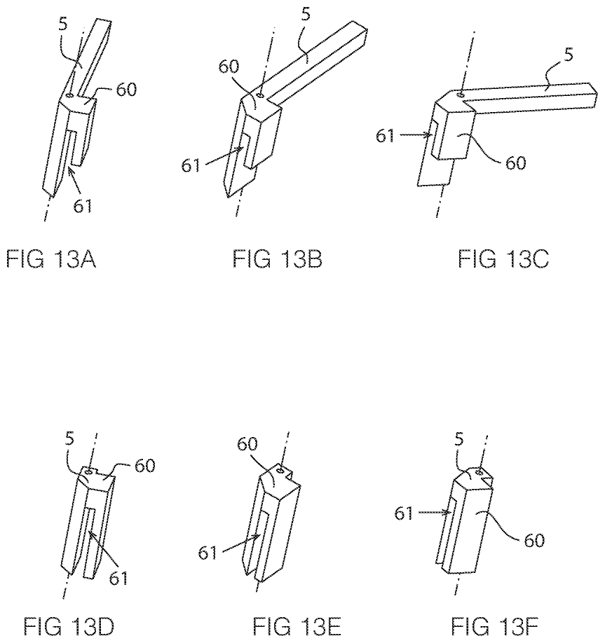

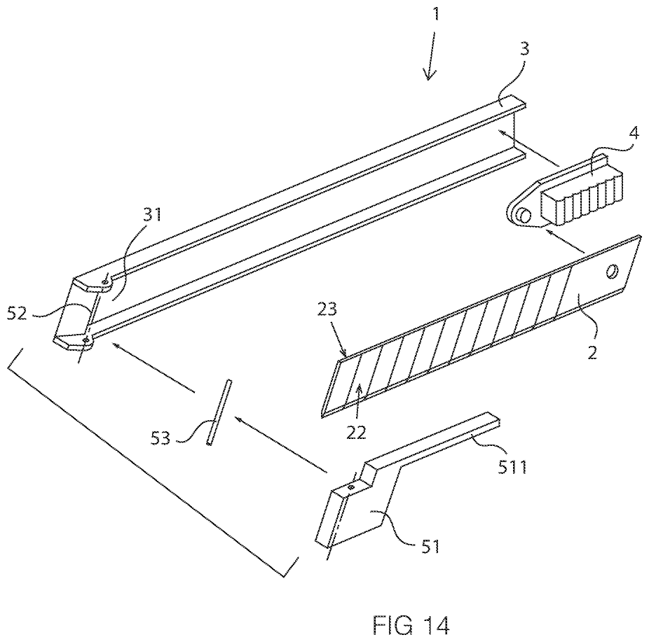

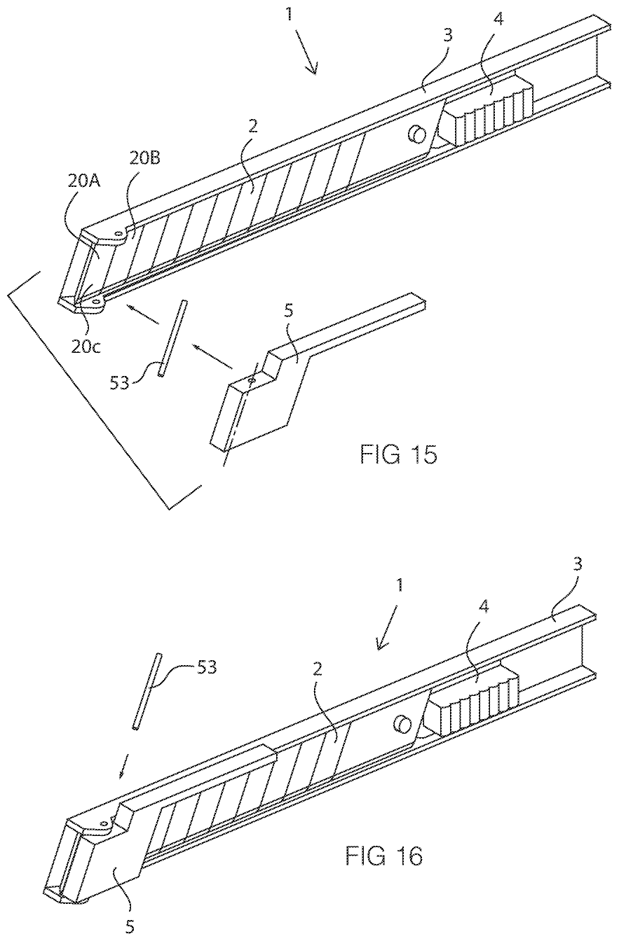

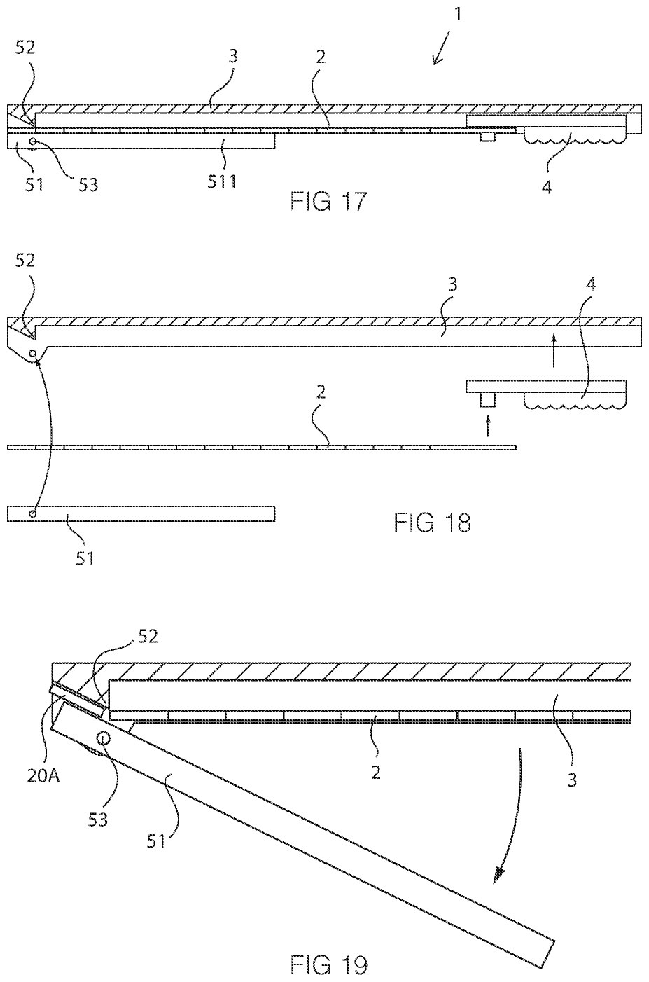

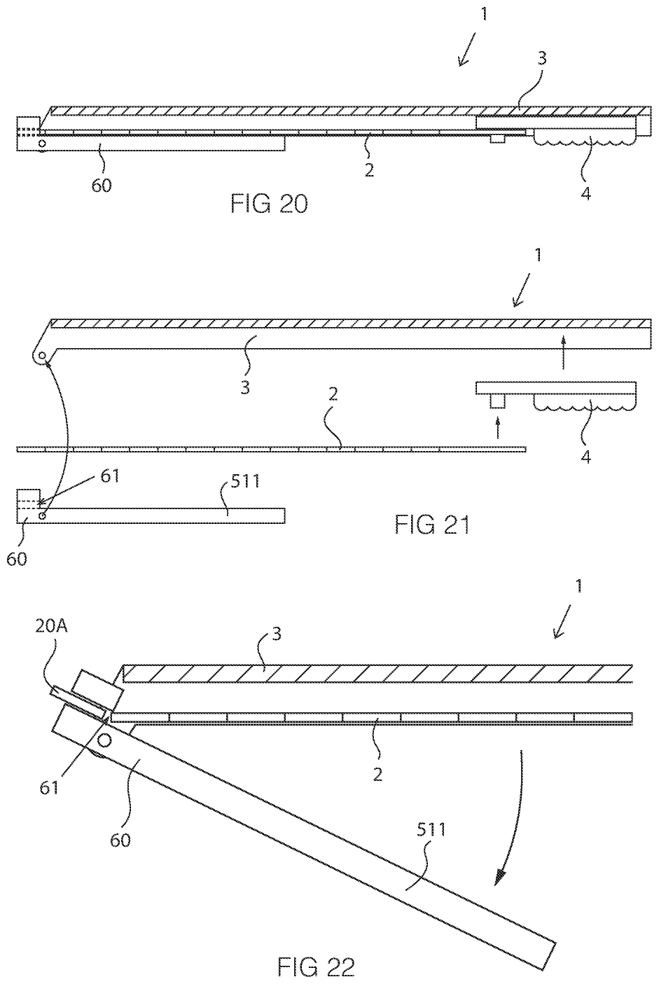

FIGS. 9-12 depict the sliding blade with the snap-off mechanism (5) that includes the main piece (60) with the narrow passage (61). FIGS. 13A-13C depict the main piece (60) with the narrow passage (61) and a handle and FIGS. 13D-13F depict the main piece (60) with the narrow passage (61) without the handle so that the user can rotate it by his fingers or by pushing it on a hard surface. FIGS. 14-15 are an exploded view of the box cutter knife (1), FIG. 16 depicts the box cutter knife (1), FIG. 17 is an upper cross-sectional view the box cutter knife (1), FIGS. 18-19 are an exploded upper cross-sectional view the box cutter knife (1), FIG. 20 is an upper cross-sectional view the box cutter knife (1), and FIGS. 21-22 are an exploded upper cross-sectional view the box cutter knife (1).

What is claimed is:

1. A box cutter knife, comprising:
a housing handle,
a sliding blade that comprises a plurality of blade tips and a break line between any two adjacent blade tips; wherein the sliding blade is positioned inside the housing handle and is designed to slide inside the housing handle and to extend outside of the housing handle by using a sliding button,
a snap-off mechanism that comprises a pushing element and a raised resisting element; wherein the pushing element is axially connected to the housing handle by a hinge, and the raised resisting element is attached to an inner wall of the housing handle or forms part of the inner wall of the housing handle; wherein the pushing element is axially connected to the housing handle in such a way that it can be adjacent to a first side of the sliding blade, and the raised resisting element is attached to the inner wall of the housing handle or forms part of said inner wall in such a way that it can be adjacent to a second side of the sliding blade;
wherein a rotation of the pushing element can cause the pushing element to apply force onto a side of a front blade tip of the sliding blade and break it at a break line between said front blade tip and an adjacent blade tip, while the raised resisting element can exert a counter force on said break line or on said adjacent blade tip.

2. A box cutter knife, comprising:
a housing handle,
a sliding blade that comprises a plurality of blade tips and a break line between any two adjacent blade tips; wherein the sliding blade is positioned inside the housing handle and is designed to slide inside the housing handle and to extend outside of the housing handle by using a sliding button,
a snap-off mechanism that comprises a pushing element and a raised resisting element; wherein the pushing element is springy connected to the housing handle by a spring, and the raised resisting element is attached to an inner wall of the housing handle or forms part of the inner wall of the housing handle;
wherein the pushing element is springy connected to the housing handle in such a way that it can be adjacent to a first side of the sliding blade, and the raised resisting element is attached to the inner wall of the housing handle or forms part of said inner wall in such a way that it can be adjacent to a second side of the sliding blade;
wherein a push of the pushing element can cause the pushing element to apply force onto a side of a front blade tip of the sliding blade and break it at a break line between said front blade tip and an adjacent blade tip, while the raised resisting element can exert a counter force on said break line or on said adjacent blade tip.

3. A box cutter knife, comprising:
a housing handle,
a sliding blade that comprises a plurality of blade tips and a break line between any two adjacent blade tips; wherein the sliding blade is positioned inside the housing handle and is designed to slide inside the housing handle and to extend outside of the housing handle by using a sliding button,
a snap-off mechanism that comprises a main piece with a passage through which the sliding blade can pass when extending outside of the housing handle; wherein the snap-off mechanism is axially connected to the housing handle by a hinge in such a way that when the snap-off mechanism rotates it can apply force onto a side of a front blade tip of the sliding blade and break it at a break line between said front blade tip and an adjacent blade tip.
